(19) United States
(12) Patent Application Publication
(10) Pub. No.: US 2006/0110496 A1
(43) Pub. Date: May 25, 2006

(54) Low carbohydrate quesadillas

(75) Inventors: W. Richard Dyer, Wexford, PA (US); Troy Bonata, Poway, CA (US); Alecia Nelson, Encinitas, CA (US); Nicole Koenig, San Diego, CA (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: H. J. Heinz Company, Pittsburgh, PA (US)

(21) Appl. No.: 11/050,024

(22) Filed: Feb. 4, 2005

Related U.S. Application Data
(60) Provisional application No. 60/630,240, filed on Nov. 24, 2004.

(51) Int. Cl. A21D 13/00

(52) U.S. Cl. 426/94

(57) ABSTRACT

A quesadilla assembled from a filling and a flour tortilla, having a substantially reduced carbohydrate level. Soy flour, wheat gluten, wheat protein isolate, and resistant wheat starch, and lecithin effect the reduced carbohydrate content. The flour tortilla is filled with a chicken, cheese, and salsa mixture to make the quesadilla.

### REFERENCE TO PROVISIONAL APPLICATION

This application relies on and incorporates by reference U.S. Provisional Patent Application Ser. No. 60/630,240, filed Nov. 25, 2004, for “Ethnic Mexican Foods” by W. Richard Dyer, Troy Bonata, Alecia Nelson, and Nicole Koenig.

### FIELD OF THE INVENTION

This invention relates generally to ethnic Mexican foods. More specifically, this invention concerns a quesadilla having a low carbohydrate content.

### BACKGROUND OF THE INVENTION

Recently, consumers have embraced diets with low carbohydrate consumption as a means for lowering personal body weight. The carbohydrates to be reduced are the sugars and starches found in fruits, vegetables, grains and milk products. Carbohydrate nomenclature can be confusing. Sugars can be either monosaccharides (e.g., glucose, fructose, and galactose) or disaccharides (e.g., sucrose, lactose, and maltose). Starches typically comprise multiple linked glucose units (i.e., polysaccharides). While fibers are also polysaccharides made up mostly of glucose units, the monosaccharides of fibers are bonded differently, not broken down by human enzymes, and typically are not absorbed in the digestive process.

This invention broadly involves the assembly of a tortilla and a filling to form a quesadilla. In particular, the invention relates to a particular process and formulation for a flour tortilla to be used making a quesadilla which has the property of a substantially reduced carbohydrate content as compared to conventional flour tortillas and quesadillas.

### SUMMARY OF THE INVENTION

A quesadilla according to this invention includes a flour tortilla having a low carbohydrate content and a filling. Tortilla flour and soy flour provide a substantially reduced carbohydrate content for the flour tortilla as compared with conventional flour tortillas.

The invention further comprises a process for making a food item by combining a portion of tortilla flour with a portion of soy flour, and a portion comprising wheat gluten, wheat protein isolate, and resistant wheat starch. After adding dough modifiers, shortening and glycerine, the ingredients are mixed at slow speed followed by a high speed mix to form a dough. The dough is divided into portions which are proofed, pressed and baked to provide a generally circular disk.

After applying a filling to a portion of the disk, a second portion of the disk is folded over the filling and the first portion, rolled to enclose the filling, and frozen.

Reconstitution of the food item can be effected by baking, pan frying, or microwave heating, but preferably occurs by pan frying.

### BRIEF DESCRIPTION OF THE DRAWING FIGURES

Many objects and advantages of this invention will be apparent to those skilled in the art when this written description is read in conjunction with the attached drawings, wherein like reference numerals have been applied to like elements, and wherein:

FIG. 1 is a schematic flow chart of the steps involved in preparing a tortilla for use in this invention;

FIG. 2 is a schematic flow chart of the steps involved in preparing a sauce for use in this invention;

FIG. 3 is a schematic flow chart of the steps involved in preparing a quesadilla filling;

FIG. 4 is a schematic flow chart of the steps involved in assembling a quesadilla according to this invention; and

FIGS. 5A, 5B, and 5C are schematic illustrations of the quesadilla of this invention during assembly.

### DETAILED DESCRIPTION OF THE INVENTION

Ethnic foods such as tortilla are generally made using corn flour (corn tortillas) or wheat flour (flour tortillas). Standard flour tortillas, approximately 6 inches in diameter, weigh about 32 g. (1.1 oz) and have a carbohydrate content of 18 g. See, USDA, Nutritive Value of Foods, Home and Garden Bulletin No. 72, item no. 661. Moreover, typical recipes for making tortillas require substantial quantities of water to make tortilla dough. See, for example, the recipes available at the following URLs: dianaskitchen.com/page/bread/tortilla.htm; dianaskitchen.com/page/bread/bisquic.htm; texasrollingpins.com/tortillarecipe.html; and texmextogo.com/recipes_tortilla.htm.

The ethnic food items of this disclosure include a flour tortilla having substantially reduced carbohydrate content as compared to the standard flour tortilla. Preferably, the carbohydrate of the flour tortillas of this disclosure is about ⅔ the carbohydrate content of standard flour tortillas, more particularly about 12 g of carbohydrate vs. the 18 g of carbohydrate in the standard flour tortilla.

Carbohydrate reduction is accomplished by changing the formulation for tortilla dough and processing techniques. Suitable preferred ingredients for a tortilla according to the present invention are set forth in Table 1 below.

TABLE 1

| Ingredient | Range, wt % |
|---|---|
| Tortilla flour | About 15 to about 22% |
| Soy flour | About 14 to about 21% |
| Wheat gluten | About 5 to about 8% |
| Wheat protein isolate | About 3 to about 5% |
| Resistant wheat starch | About 4 to about 6% |
| Dough conditioner | About 0.2 to about 0.3% |
| Baking powder | About 0.5 to about 3% |
| Vegetable shortening | About 6 to about 10% |
| Granulated salt | About 0.5 to about 1% |
| White granulated sugar | About 0.1 to about 0.3% |
| Lecithin | About 0.2 to about 0.5% |
| Liquid glycerin, 99% | About 0.4 to about 0.7% |
| Water | About 22 to about 51% |

The recipe of Table 1 includes several novel ingredients in tortilla production. The first novel ingredient is a mid protein content wheat flour, known commercially as tortilla flour, to provide strength, extended shelf life and overall quality to the resulting tortilla. Preferably, the protein content is in the range of about 10 to about 12%. High protein wheat flours (e.g., with protein content over about 12%) have been found to result in product that is too tough and unpliable; whereas low protein wheat flours (e.g., with protein content in the range of 8 to about 10%) have been found to result in product that is too soft and sticky.

Another novel ingredient of the flour tortilla according to this invention is soy flour. In the past, flour tortillas have been made using wheat flour. Soy flour exhibits substantially lower carbohydrate content and considerably higher protein content as compared to conventional wheat flour. More particularly, standard defatted soy flour has a carbohydrate content of 38.4% and a protein content of 47%; whereas standard unenriched all-purpose white wheat flour has a carbohydrate content of 76.3% and a protein content of 10.3%. Standard tortilla flour, by comparison, has a carbohydrate content of 67% and a protein content of 9.7%. Thus, the soy flour has about 50% of the carbohydrate content of standard wheat flour and nearly 5 times the protein content of standard wheat flour.

Another novel ingredient, wheat gluten, provides structure for the protein matrix of the dough. Wheat protein isolate, yet another novel ingredient, available commercially as Arise 5000, is a soluble wheat protein isolate that improves dough rheology through increased water absorption and elimination of dough bulkiness. Resistant wheat starch, also a novel ingredient available commercially as Fiberstar 70, works in conjunction with the wheat protein isolate to deliver dietary fiber having a low water-holding capacity.

As Table 1 demonstrates, the combination of wheat gluten, wheat protein isolate, and resistant wheat starch is approximately equal to the proportion of soy flour, and to the proportion of tortilla flour used in the tortilla recipe.

Yet another novel ingredient, lecithin, functions as an emulsifier to increase moisture retention. Lecithin also functions as a releasing agent as it provides a barrier to minimize sticking.

This invention concerns not only a flour tortilla made using these novel ingredients but also the process for making such a tortilla because both the ingredients and the process of combining them with other ingredients is novel and central to the novel flour tortilla of this specification.

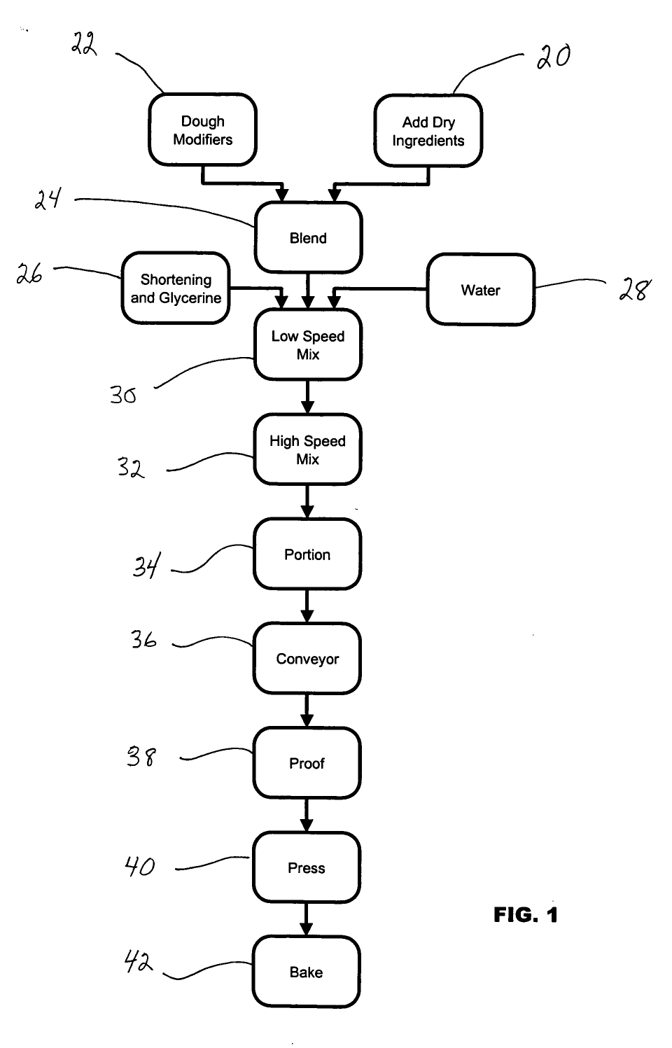

Turning now to FIG. 1, the process of making a novel flour tortilla starts with the addition of dry ingredients 20 to the hopper of a suitable conventional three-bar mixer that is modified to accommodate the changed rheology of the dough. Specifically, the modification involves the addition of a stationary bar to the mixer. The stationary bar has a diameter approximately the same as the diameter of the moving bars of the mixer. The stationary bar is positioned in the mixer parallel to the axis of rotation for the three-bar carriage and spaced radially so that the bars of that carriage pass without interference. The minimum spacing between the stationary bar and the rotating bars is about the same as the diameter of those bars. With this modification, additional shear forces are applied to the dough while it is being mixed.

The dry ingredients which are added include the soy flour, wheat gluten, wheat protein isolate, and modified wheat starch. At the same time, the wheat flour is added as well as dough modifiers 22 including a dough conditioner. baking powder, lecithin, salt and sugar. The dough conditioner interacts with the soy flour and low carbohydrate ingredients to build strength in the dough. The baking powder provides cellular structure in the dough and makes the product tender. Both the sugar and the salt provide flavor, but also aid the cellular structure, while functioning as process aids, and enhancing tenderness in the resulting product.

The dry ingredients are then blended 24. The blending operation may proceed for about 30 seconds at a low speed. For purposes of this description, a low speed on the order of about 35 rpm is suitable.

After the blending step 24, vegetable shortening and liquid glycerin 26 (at about 99% purity) are added to the blended ingredients, followed by the addition of warm water. The vegetable shortening helps flavor the resulting tortilla, but also functions as a processing aid, and improves tenderness of the resulting tortilla. Glycerin emulsifies and improves machinability of the dough by reducing its stickiness, while also improving tenderness of the resulting flour tortilla. Water at a temperature preferably in the range of about 85° to about 90° F. is used. Water in this temperature range enhances the later step of proofing the dough.

With all the ingredients now in the mixer, a two-step mixing process takes place. In the first step or stage 30, the mixer operates at a slow speed of about 35 rpm for a period of about five minutes. In the second step or stage 32, the mixer operates at a high speed of about 70 rpm for a shorter period of about two and a half minutes. During the first stage mix 30, the dry ingredients are blended with the wet ingredients. Then, during the second stage mix 32, the ingredients are processed to form a substantially uniformly textured mass of dough that is medium to fully developed.

That dough is the portioned 34 by, for example, dumping the dough mass into a suitable conventional dough chunker and is then transferred to a suitable conventional divider/rounder. There, the batch of dough is divided or separated into individual portions that may be generally in the shape of a ball. Typically, the individual portions are sized to about 1.1 oz to account for weight loss that occurs during further processing so that the finished flour tortilla has a weight of about 1.0 oz. for a flour tortilla with a nominal diameter of about 6 inches.

The individual dough ball portions may be deposited on a conveyor 36 that moves the dough balls into and through a proofer where the dough balls are proofed 38, if necessary. Whether or not proofing is required depends upon ambient weather conditions. When used, the proofing step occurs at a temperature of about 89° to about 92° F. and a relative humidity of about 60% to about 70%. The proofing step may last up to about 30 minutes, but preferably lasts for about 10 minutes. During the proofing step, the leavening agents in the dough have time to work and establish the cellular characteristics desired in the final tortilla product.

When the proofed dough chunks leave the proofing step 38, they are pressed 40 to make substantially circular disks of dough. These disks have a nominal diameter in the range of about 5 inches to about 8 inches, and preferably about 6 inches. The range of actual tortilla diameter may, of course, vary relative to the nominal diameter. For example, for tortilla having a nominal diameter of about 6 inches, actual diameters may range between about 5.75 inches and 6.5 inches. Moreover, as a result of the pressing step, the disks are flattened to have a substantially uniform thickness.

The shaped tortilla dough then advances by conveyor to and through an oven where the baking step 42 occurs. Baking 42 occurs at temperatures in the range of about 200° to 370° F. for a duration of about 25 to about 30 seconds. The flour tortilla resulting from this process exhibits substantially reduced carbohydrate content, for example, on the order of 12 g for a nominal 6 inch tortilla, as compared to standard flour tortilla recipes. Moreover, the flour tortilla is tender and flexible, has uniform toast marks, and is suited for use in other ethnic food products.

By way of example, the flour tortillas can be used in the production of low carbohydrate quesadillas where a filling is applied to the tortillas. While many different quesadilla fillings may be used, a combination of chicken and cheese with a salsa is often selected for the filling.

On a commercial scale a salsa for use in quesadillas may be fashioned from the ingredients set out in Table 2 below.

TABLE 2

| Ingredient | Wt. % |
|---|---|
| Crushed Tomatillos | About 15 to about 25% |
| Corn Oil | About 4 to about 10% |
| Soy Sauce | About 1 to about 5% |
| Modified Starch | About 0.5 to about 2.5% |
| Salt | About 1 to about 2% |
| Cilantro | About 0.2 to about 1.5% |
| Gelatin | About 0.1 to about 0.7% |
| Xanthan Gum | About 0.1 to about 0.6% |
| Mesquite Chicken Flavor | About 0.1 to about 0.5% |
| Disodium I + G | About 0.05 to about 0.30% |
| Water | About 65 to about 80% |

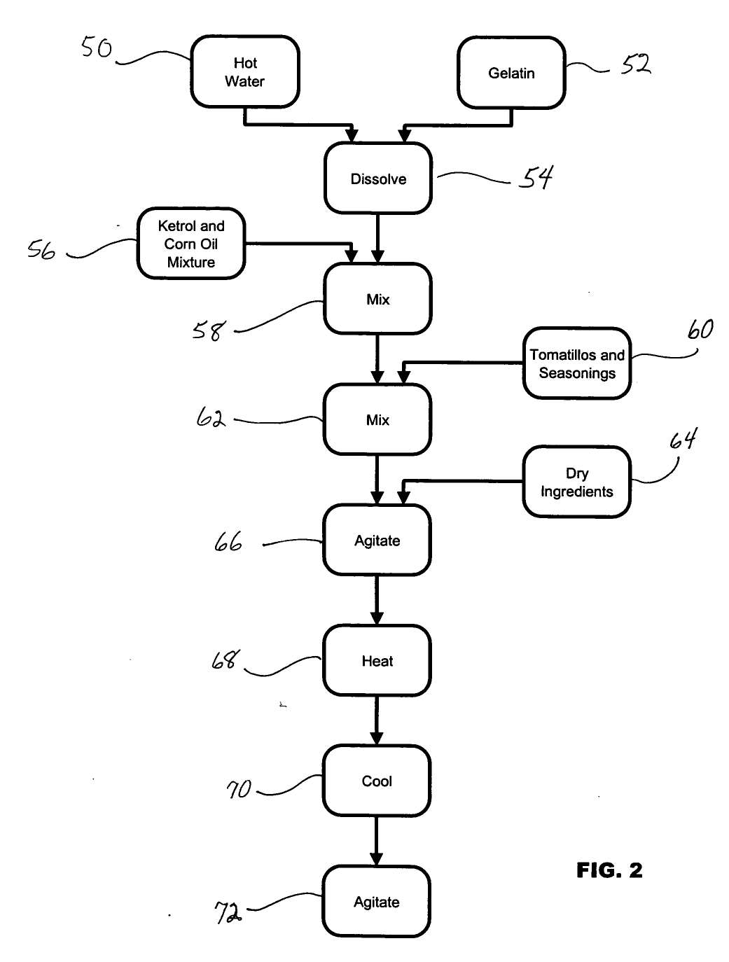

The process of making the salsa starts, see FIG. 2, by putting the ambient water 50 in a kettle or other suitable mixing vessel and slowly adding the gelatin 52 and heating the solution until the gelatin is dissolved 54 in the hot water.

The corn oil and xanthan gum, available commercially as Keltrol, are mixed 56 and added to the kettle containing the gelatin and water solution where all those ingredients are mixed. The tomatillos, soy sauce, and seasonings 60 are then added to the kettle and mixed 62. While the kettle contents are continuously agitated 66, the dry ingredients 64 are added. The dry ingredients may include salt, disodium inosinate and disodium guanylate available commercially as disodium I+G, modified starch such as Col Flo 67, and flavoring(s).

With all ingredients in the kettle, the kettle is heated 68 until the contents reach a temperature of about 190° F. Preferably steam is used to heat the kettle as it reduces the likelihood of hot spots developing in the kettle. Nevertheless, any other suitable conventional heating process can be used.

Then, the heated salsa is cooled 70 to a temperature in the range of about 35° to about 40° F. while being agitated 72. The cooling step 70 can be accomplished using a cooling jacket through which cold water is circulated. However, other suitable conventional cooling techniques can also be used.

The resulting salsa preferably has a gelatinous, almost translucent appearance with a greenish color and visible seeds.

Ingredients for a suitable chicken and cheese filling to make quesadillas using the low carbohydrate flour tortilla and the salsa described above are set out in Table 3 below.

TABLE 3

| Ingredient | Wt. % |
|---|---|
| White Meat Chicken Strips | About 16 to about 22% |
| Salsa | About 17 to about 22% |
| Mozzarella Cheese | About 15 to about 18% |
| Jack Cheese Sauce | About 8 to about 12% |
| Diced Cheddar Cheese | About 7 to about 9% |
| Diced Monterey Jack Cheese | About 7 to about 9% |
| Diced Green Del Sol Chiles | About 4 to about 7% |
| Diced Onion | About 4 to about 6% |
| Diced Red Bell Pepper | About 4 to about 6% |
| Thickener | About 0.5 to about 2% |

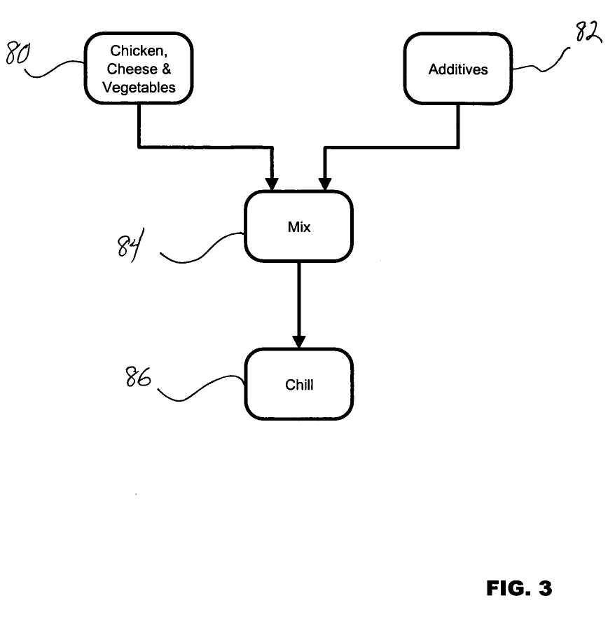

The chicken, cheeses, salsa, and vegetables 80 (see FIG. 3) are combined and mixed in a suitable conventional vessel. That mixture, along with the additives 82, such as thickeners like the starch-based thickener available commercially as Ultra Sperse, and methylcellulose esters available commercially as Methocel, are placed in a suitable conventional mixer where they are mixed 84 for about 40 seconds at a speed of about 22.5 rpm to blend those ingredients. Then, the blended mixture is chilled or cooled 86 with CO₂ until its temperature is reduced to the range of about 26° to about 27° F. The chilled, blended mixture is then ready for use in assembling a quesadilla.

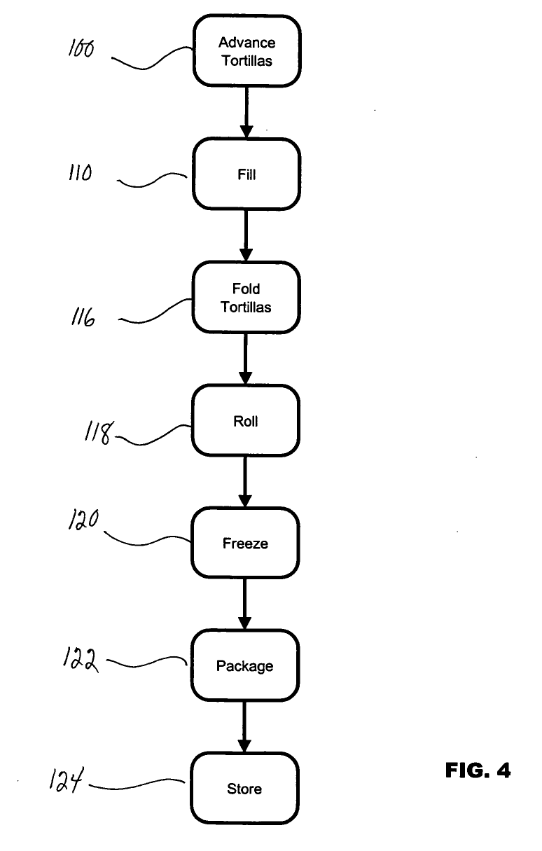

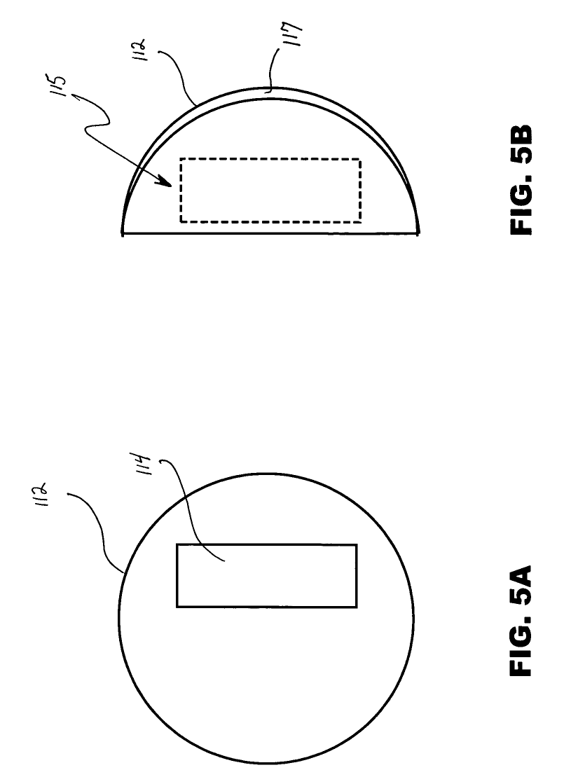

Turning now to FIG. 4, to assemble a quesadilla, the reduced carbohydrate tortilla are advanced 100 to a suitable conventional filling machine. The filling is extruded 110 onto the top of each tortilla 112 (see FIG. 5A) at a location adjacent to a diameter of the tortilla. The filling 114 is spaced from the peripheral edges of the tortilla 112.

The tortilla 112 is then folded over the filling 114 (see FIG. 5B) so that the generally semicircular edges of the tortilla nearly overlap and the filling 114 is completely covered by the tortilla. The folded tortilla 116 (see FIG. 4) is then rolled 118 to provide uniform thickness to the resulting quesadilla. As best seen in FIG. 5B, the assembled quesadilla 115 has a generally semicircular shape, with the overlapping portions of the tortilla 112 defining a small area 117 free of overlap when viewed from the top. The assembled quesadillas 115 are immediately frozen 120 (see FIG. 4) to a final temperature of about 25° F. or less in a suitable conventional freezer. A spiral freezer can be used for this freezing step and the desired temperature can be attained in a period of about 35 to 36 minutes. Frozen quesadillas are then packaged 122 and stored 124 for subsequent distribution and sale.

When purchased by a consumer, these quesadillas can be reconstituted by heating in a microwave oven, baking in a conventional oven, or by pan frying.

Throughout this specification references have been made to percentages. Unless otherwise apparent from the context, such references to percentages are references to percentages by weight. Moreover, to the extent that numerical values are introduced by terms such as “about”, those numerical values are intended to include values within a range of 5% above and below the nominal numerical value.

It will now be apparent to those skilled in the art that a new, and improved process for making a low carbohydrate quesadilla has been described. It will also be apparent to those skilled in the art that numerous modifications, variations, substitutions, and equivalents exist for features of the process and resulting product. Accordingly, it is expressly intended that all such modifications, variations, substitutions, and equivalents which fall within the spirit and scope of the invention as defined by the appended claims shall be embraced thereby.

1. A food item comprising:
a flour tortilla having first and second portions, and containing soy flour; and
a filling applied to the first portion of the flour tortilla, and covered by the second portion of the flour tortilla;
wherein the flour tortilla has a carbohydrate content substantially lower than the carbohydrate content of a standard flour tortilla.

2. The food item of claim 1 wherein the carbohydrate content is preferably no greater than ⅔ of the carbohydrate content of a standard flour tortilla.

3. (canceled)

4. The food item of claim 1 wherein the flour tortilla contains tortilla flour and soy flour in comparable proportions.

5. (canceled)

6. The food item of claim 1 wherein the flour tortilla includes lecithin.

7. (canceled)

8. (canceled)

9. (canceled)

10. (canceled)

11. (canceled)

12. (canceled)
